(19) United States
(12) Patent Application Publication
(10) Pub. No.: US 2007/0017999 A1
(43) Pub. Date: Jan. 25, 2007

(54) Credit card storing metal case

(75) Inventor: Yuan-Chih Liu, Chung-Hwa Hsien (TW)

Correspondence Address: TROXELL LAW OFFICE PLLC;SUITE 1404, 5205 LEESBURG PIKE, FALLS CHURCH, VA, 22041, US

(73) Assignee: Sing-Shine Leather and Metal Co., Ltd.

(21) Appl. No.: 11/256,159

(22) Filed: Oct. 24, 2005

(30) Foreign Application Priority Data
Jul. 20, 2005 (TW) 094212294

(51) Int. Cl. G06K 7/00

(52) U.S. Cl. 235/486

(57) ABSTRACT

The present invention is related to a credit card storing metal case, especially a portable device that provides storage of personal belongings, immediate access, convenience and security. The metal case, depending on practical needs, can be carried with personal accessories, like belts and backpacks, to possess great portability; or properly combined with indoor decorations and furniture, like sofas and chair armrests, to achieve a proper storage effect. Especially, the metal storing device is a grooved case with a case insert or a snap-lock mechanism comprising a notched base unit and a cover can provide space for the storage of carried personal belongings such as credit cards and business cards. Thus, the metal case provides great benefits because the user can have easy access to the stored object with great mobility, convenience and security.

### BACKGROUND OF THE INVENTION

1. Field of the Invention

The present invention is related to a credit card storing metal case, especially a portable device that provides storage of personal belongings, immediate access, convenience and security. The metal case, depending on practical needs, can be carried with personal accessories, like belts and backpacks, to possess great portability; or properly combined with indoor decorations and furnitures, like sofas and chair armrests, to achieve a proper storage effect.

2. Description of the Prior Art

Usually, people would select the bags or backpacks in proper size according to the amount of objects that are carried out and like to have the convenience that immediate access to these objects is possible when the practical need arises.

Under certain situations, people would place light, thin, short and small objects, like credit cards and business cards, in the wallet. But when the amount of small objects is large, the wallet will swell and hurt aesthetics when it is in a pocket. If a purse is used to hold the small objects, it may look unnecessary.

Therefore, to properly arrange personal belongings that are carried out and alleviate the burden of carrying a backpack or a purse and to provide convenience and lightweight portability are the objectives of the present invention.

### SUMMARY OF THE INVENTION

The primary objective for the invention is to provide a credit card storing metal case in which a grooved case with a case insert or a snap-lock mechanism comprising a notched base unit and a cover can provide space for the storage of carried personal belongings such as credit cards and business cards. The metal case can be equipped with personal accessories like belts and backpacks to provide mobility or with interior decoration or furniture to provide storage function. Thus, the user can have easy access to the stored object with great mobility, convenience and security.

To familiarize those skilled about this technique with the structural features and function for the present invention, several preferred embodiments are described with illustration as follows:

### DETAILED DESCRIPTION OF THE PREFERRED EMBODIMENTS

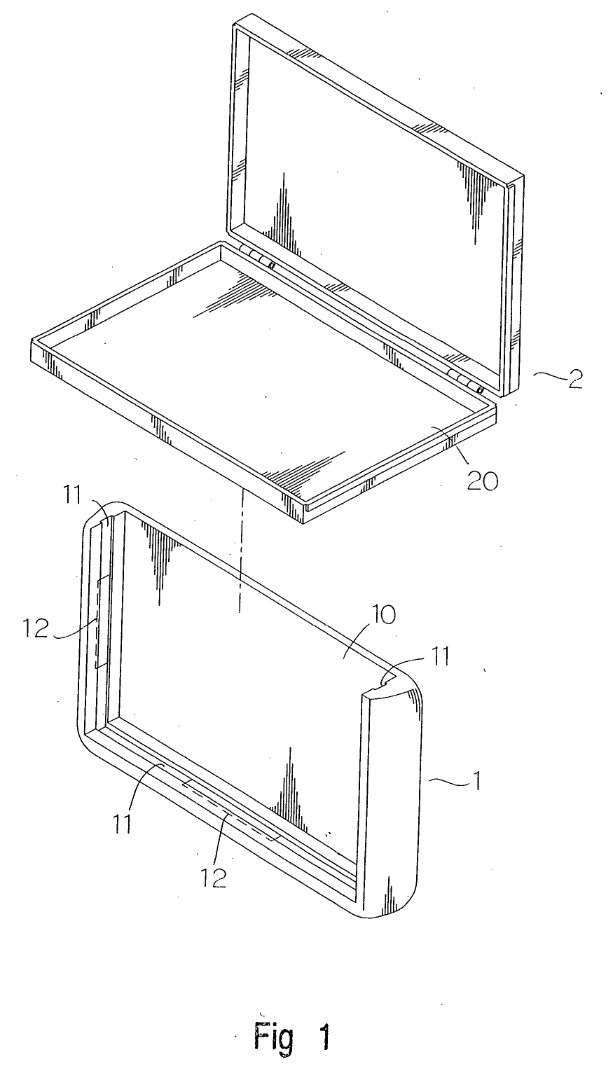

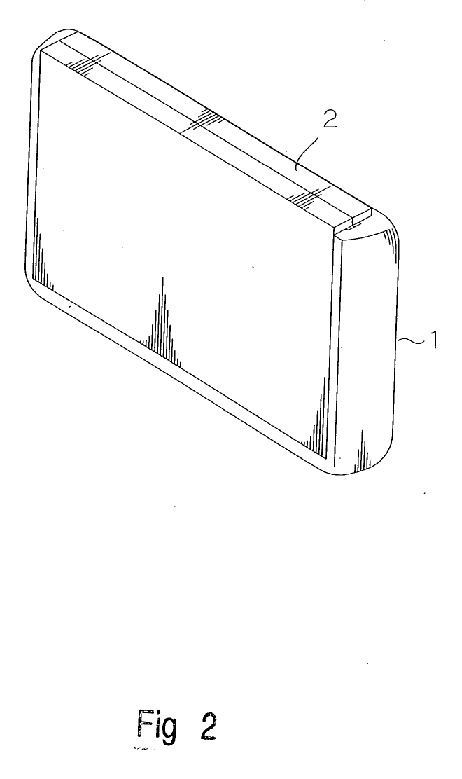

Please refer to FIG. 1 and FIG. 2, which disclose the disassemble diagram and assemble diagram for credit card storing metal case in the present invention. The components in the figures include:

A metal case (1), which has cavity (10) with slide rail (11) at periphery and magnet (12) installed at the proper position inside the slide rail (11);

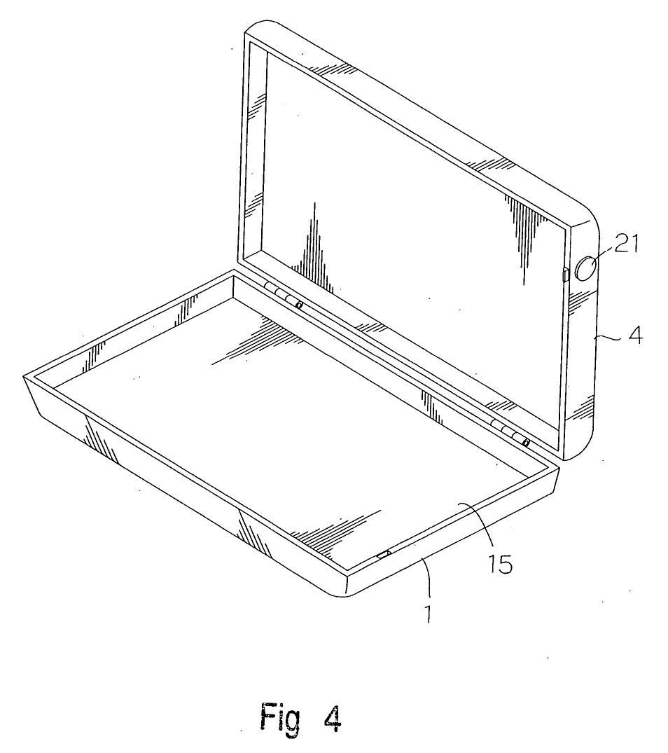

A shallow case (2), with space (20) provide to store things like credit cards and business cards, which can be inserted into the above slide rail (11) and fit into the metal case (1) and use magnets (12) for tight connection. The shallow case (2) closes up through a button lock (21) (as shown in FIG. 4). To open the case, the same button lock (21) needs to be pressed manually.

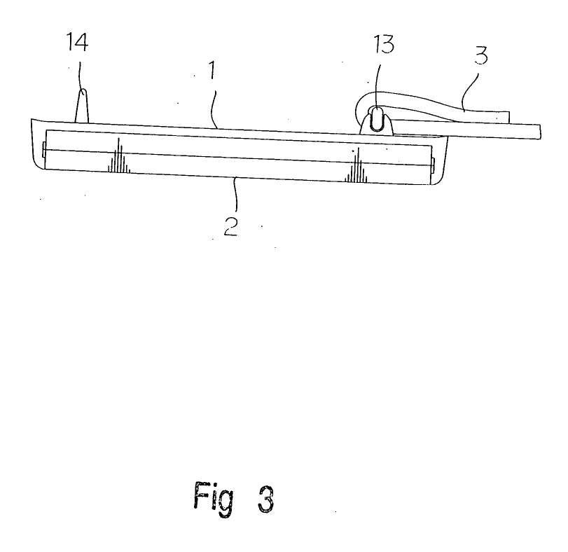

Further, at a proper position on the back of the metal case (1), a hinge (13) and a connector (14) are provided for positioning when the metal case is combined with a belt (3), so the connector (14) can selectively connect to the holes (30) on the belt (3) (not shown in the figure). Thus, a convenient way of utilizing the metal case with a belt (3) is provided as in FIG. 3.

Accordingly, the user can store carried objects like credit cards and business cards in the shallow case (2) and have the shallow case (2) inserted into the metal case (1) that is connected with the belt (3), so the shallow case (2) can be accessed and opened immediately when the need arises and returned to the cavity (10) of the metal case (1).

Please refer FIG. 4 for another type of metal case (1), which components include at least:

a metal case, which surface has a notch (15);

a cover (4), connected to one side of the cavity (15), so it fits with the metal case (1); besides, a repositioning spring (40) (not shown in the figure) is located at the connection between the cover (4) and the cavity (15), and a button lock (21) is used to close the case, therefore, the stored objects will not drop out because the spring enables the automatic closure of the case after the case is open and the object is taken out.

Accordingly, the user can open the cover (4) for the metal case (1) when it is connected to a belt (3) on the user and take out credit cards or business cards immediately, and release the cover (4) quickly back to a closure state through the repositioning spring (40). The invention provides a great deal of convenience to the user.

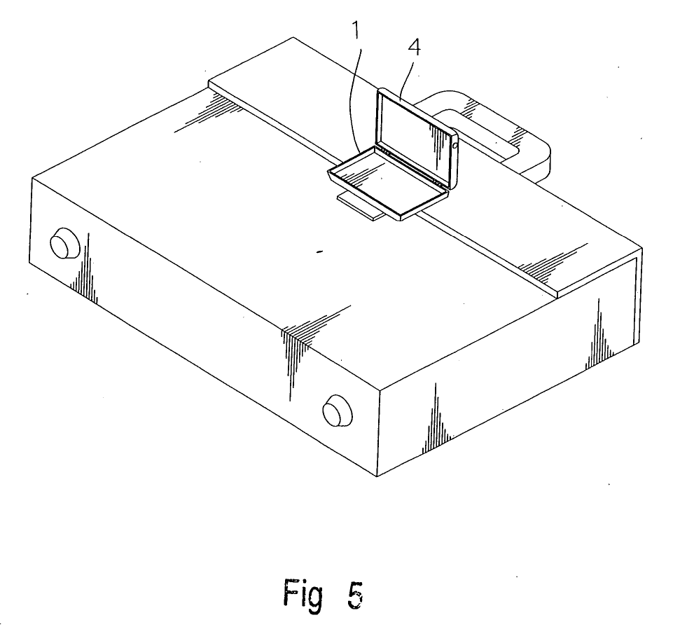

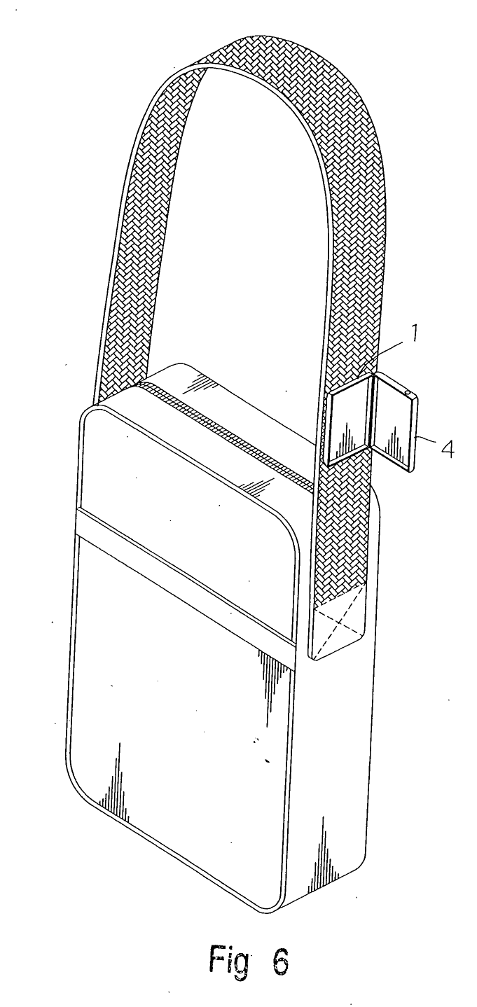

Moreover, as shown in FIG. 5 and FIG. 6, the metal case (1) also has the flexibility to be used with a purse, a suitcase or a backpack etc.

Moreover, the metal case (1) in the present invention can be properly used with interior decoration or furniture, such sofas and chair armrests, so when the user sits on a sofa or a chair, personal belongings like credit cards or business cards can be placed inside the metal case (1), which provides good storage function. The cards can be readily taken out of the metal case (1) when the need arises.

In summary, the metal case in the present invention for storing credit cards can achieve the expected objectives and functions through the above-disclosed structure, and provide benefits in applicability and convenience. Such a metal case was never seen in publications and been utilized. It meets the prerequisites of novelty and progressiveness, so it is submitted for patent application.

The above disclosed explanation and illustration is the preferred embodiment for the present invention and does not intend to limit the scope of the present invention. It is justifiable that any modification intrinsically equivalent to the above-disclosed structural features and functions shall be considered within the scope of the present invention.

### SPECIFIC DRAWING

(1) The designated diagram for the present invention is FIG. 1.

(2) The legends for the components:

| | | | |
|---|---|---|---|
| Metal case | (1) | cavity | (10) |
| Slide rail | (11) | magnet | (12) |
| Shallow case | (2) | space | (20) |

### BRIEF DESCRIPTION OF THE DRAWINGS

FIG. 1 is a disassemble diagram for a preferred embodiment for the present invention.

FIG. 2 is a assemble diagram for a preferred embodiment for the present invention.

FIG. 3 is a practical application for a preferred embodiment.

FIG. 4 is the exterior structural diagram for another preferred embodiment.

FIG. 5 is a practical application for another preferred embodiment.

FIG. 6 is another practical application for another preferred embodiment.

### DESCRIPTION OF MIN COMPONENTS

| | | | |
|---|---|---|---|
| Metal case | (1) | cavity | (10) |
| Slide rail | (11) | magnet | (12) |
| hinge | (13) | connector | (14) |
| notch | (15) | space | (20) |
| Shallow case | (2) | hole | (30) |
| button lock | (21) | spring | (40) |
| belt | (3) | | |
| cover | (4) | | |

What is claimed is:

1. A credit card storing metal device, is composed of
a metal case, with cavity and slide rail at periphery;
a shallow case that can be open and closed, with space inside, capable of being inserted into the above slide rail and fitting into the metal case.

2. As described in claim 1 for a credit storing metal device, inside the slide rail, there is magnet.

3. As described in claim 1 for a credit storing metal device, the shallow case has a button lock to control its opening and closure.

4. A credit card storing device, which is composed of:
a metal case, with a surface notch;
a cover, connected to one side of notched metal case, fitting with the metal case upon closure.

5. As described in claim 4 for a credit storing metal device, there are a button lock and a repositioning spring at the connection between the cover and the notched case.
